(19) United States
(12) Patent Application Publication
(10) Pub. No.: US 2026/0277257 A1
(43) Pub. Date: Sep. 17, 2026

(54) OPTIMIZING PIPELINE CAPACITY AND EMISSIONS THROUGH DRAG-REDUCING AGENT AND PUMP POWER MANAGEMENT

(71) Applicant: Schlumberger Technology Corporation, Sugar Land, TX (US)

(72) Inventors: Kang Wang, Houston, TX (US); Adnan Chughtai, Crawley (GB); Clare Schoene, Houston, TX (US); Parag Vasant Karanjkar, Houston, TX (US); Jiaobao Jack Zhu, Houston, TX (US); Jason Reynaud, Houston, TX (US)

(21) Appl. No.: 19/079,563

(22) Filed: Mar. 14, 2025

(51) Int. Cl. G05D 7/06; F17D 3/12

(52) U.S. Cl. CPC G05D 7/0676; F17D 3/12; G05D 7/0623

(57) ABSTRACT

A method for modifying a capacity of a pipeline while reducing emissions includes receiving input data related to a pump that is configured to cause a fluid to move through a pipeline. The method also includes determining an operating point of the pump. The method also includes generating a system curve based upon the input data and the operating point. The method also includes generating a drag reduction efficiency curve based upon the input data. The method also includes updating the system curve based upon the drag reduction efficiency curve to produce an updated system curve. The method also includes updating the operating point based upon the input data and the updated system curve to produce an updated operating point.

### BACKGROUND

Drag reducing agents (DRAs) are chemical additives that are in the pipeline industry to aid in producing and transporting crude oils, most frequently across long-distance land-based pipelines. A DRA injection may reduce flow turbulence and frictional pressure, which may increase pipeline flow capacity. DRAs have a broad range of applicability to crude oils (e.g., with API gravity from 10 to 60) under many types of production and transportation environments. DRAs can be continuously injected without downtime or product alteration, to increase the production flow to the wellhead, to gathering sites, from offshore platforms to shore, and most frequently, across long-distance land-based pipelines. Due to their reliability and added flexibility for operators, sometimes the designers of new pipeline systems may even consider the use of DRAs in their design. What is needed is an improved system and method for optimizing pipeline capacity and emissions through DRAs and pump power management.

### SUMMARY

A method for modifying a capacity of a pipeline while reducing emissions is disclosed. The method includes receiving input data related to a pump that is configured to cause a fluid to move through a pipeline. The method also includes determining an operating point of the pump. The method also includes generating a system curve based upon the input data and the operating point. The method also includes generating a drag reduction efficiency curve based upon the input data. The method also includes updating the system curve based upon the drag reduction efficiency curve to produce an updated system curve. The method also includes updating the operating point based upon the input data and the updated system curve to produce an updated operating point.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving input data. The input data includes a pump curve corresponding to a pump that causes a fluid to move through a pipeline. The operations also include determining an operating point of the pump where the pump operates at or above a predetermined efficiency. The operations also include generating a system curve based upon the input data and the operating point. The system curve is generated without introducing a drag-reducing agent (DRA) into the pipeline. The operations also include generating a drag reduction efficiency curve based upon the input data. The drag reduction efficiency curve represents an amount of a reduction in drag in the pipeline in response to the DRA being introduced into the fluid in the pipeline. The operations also include updating the system curve based upon the drag reduction efficiency curve to produce an updated system curve. The operations also include updating the operating point based upon the input data and the updated system curve to produce an updated operating point. The updated operating point is also based upon a concentration of the DRA and/or a power consumption of the pump.

A non-transitory computer-readable medium is also disclosed. The medium stores instructions that, when executed by one or more processors of a computing system, cause the computing system to perform operations. The operations include receiving input data. The input data includes a pump curve corresponding to a pump that causes a fluid to move through a pipeline. The operations also include determining an operating point of the pump where the pump operates at or above a predetermined efficiency. The operations also include generating a system curve based upon the input data and the operating point. The system curve is generated without introducing a drag-reducing agent (DRA) into the pipeline. The operations also include generating a drag reduction efficiency curve based upon the input data. The drag reduction efficiency curve represents an amount of a reduction in drag in the pipeline in response to the DRA being introduced into the fluid in the pipeline. The operations also include updating the system curve based upon the drag reduction efficiency curve to produce an updated system curve. The operations also include updating the operating point based upon the input data and the updated system curve to produce an updated operating point. The updated operating point is also based upon a concentration of the DRA and a power consumption of the pump. The operations also include automatically performing an action in response to the updated operating point and an operational objective.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1A illustrates a schematic view of a pipeline with a plurality of (e.g., four) operating pump stations, and FIG. 1B illustrates a schematic view of a DRA injection skid that is a part of the pipeline, according to an embodiment.

FIGS. 2A-2C illustrate a flowchart (FIG. 2A), a graph (FIG. 2B), and a table (FIG. 2C) for optimizing pipeline capacity and emissions, according to an embodiment.

FIG. 3 illustrates a DR % curve range of a DRA, according to an embodiment.

FIG. 4 illustrates a graph showing how to select an optimal operation point, according to an embodiment.

FIG. 5 illustrates a flowchart of a method for modifying (e.g., optimizing) a capacity of a pipeline while reducing emissions, according to an embodiment.

FIG. 6 illustrates a schematic view of a system for autonomously optimizing a drag reducer, according to an embodiment.

FIG. 7 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

Pipeline energy consumption often contributes millions of tons of carbon dioxide CO₂ annually. The present disclosure includes a method that optimizes the drag reducing agent (DRA) dosage and pump power simultaneously, to flexibly reduce the pipeline energy consumption (e.g., scope 2 emissions), maximize pipeline flow capacity, or both. It also aids practical operational considerations such as flow increase, energy spikes, constraint removal, debottlenecking, pressure reduction, emission reduction etc.

The method leverages pump performance curves, pipeline system hydraulics behavior, DRA efficiency curve, real-time utility cost data, and system constraints (e.g., max allowable operating pressure (MAOP)) to identify the optimal operating point based on the pipeline's specifications. When data availability permits, a custom machine learning model may be built to improve the accuracy of the DRA efficiency curve. Further, the method may be automated via a closed-loop control system for real time optimization.

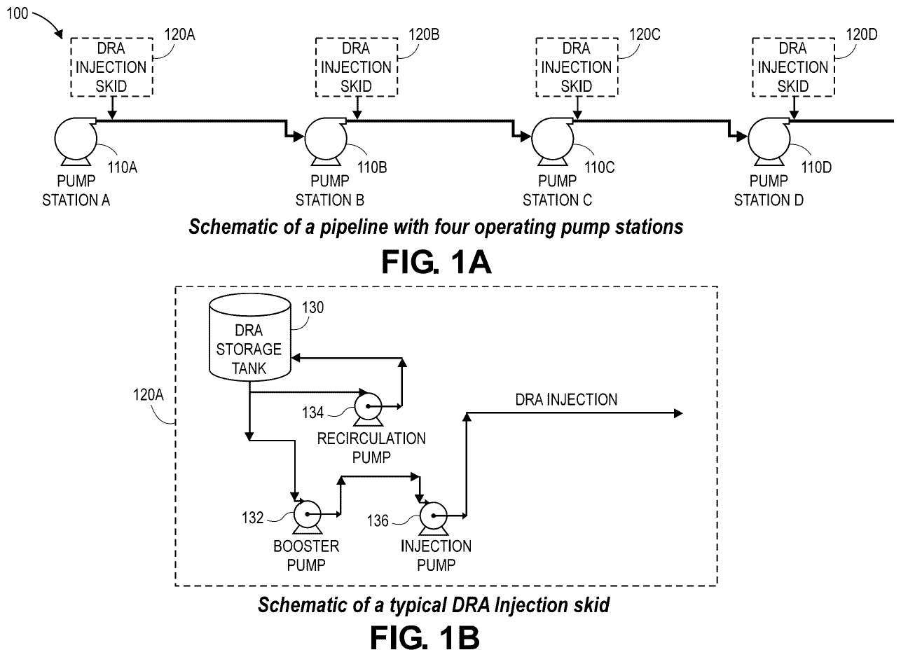

FIG. 1A illustrates a schematic view of a pipeline 100 with a plurality of (e.g., four) operating pump stations 110A-110D, and FIG. 1B illustrates a schematic view of a DRA injection skid 120A that is a part of the pipeline 100, according to an embodiment. Downstream from each pump station 110A-110D, there may be a DRA injection skid 120A-120D. The DRA injection skids 120A-120D may include chemical (e.g., DRA) storage tanks 130, a booster pump 132, a recirculation pump 134, an injection pump 136, or a combination thereof. Multiple tanks may be connected through common suction manifold to the booster pumps 132. The booster pump 132 may feed the injection pump 136 and provide recirculation to the suction tank 130 to homogenize the fluid therein. For bigger storage tanks 130, sometimes dedicated recirculation pumps 134 may be used to unload the DRA from smaller intermediate bulk container (IBC) tanks and to ensure recirculation to the feed storage tank 130. The injection pumps may also inject the chemical (e.g., DRA) into the crude oil pipeline 100.

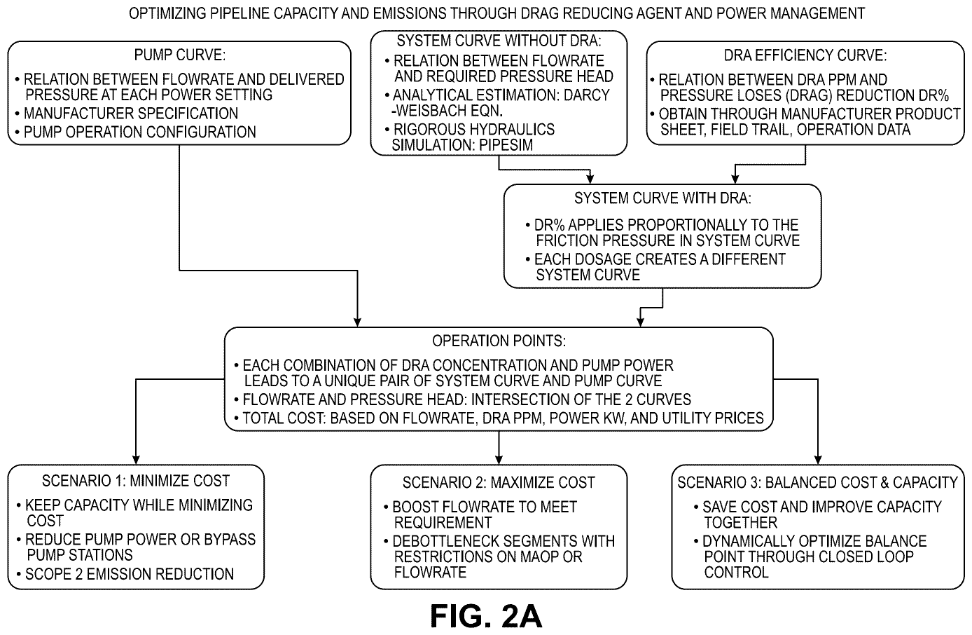

FIGS. 2A-2C illustrate a flowchart (FIG. 2A), a graph (FIG. 2B), and a table (FIG. 2C) for optimizing pipeline capacity and emissions, according to an embodiment. The flowchart summarizes the proposed method under various optimization scenarios. The graph illustrates operational points intersected by the pump curves and system curves with and without a DRA injection. The table summarizes the optimal parameters as an output of the method.

When a predetermined amount of DRA is injected into the pipeline (e.g., in the range of 1-100 ppm), flow turbulence may be reduced and frictional pressure may drop. As a result, the DRA may increase pipeline flow capacity, reduce pumping power (e.g., a source of scope 2 GHG emissions), or both. The effectiveness of the DRA may be defined by the drag reduction percentage % DR:

$$\% DR = ( 1 - \frac{Δ {P}_{D R A}}{Δ {P}_{no DRA}} ) \times 100 \% = ( 1 - \frac{{f}_{D R A}}{{f}_{no DRA}} ) \times 100 \% \qquad ( 1 )$$

where Δp is the pressure drop, and f is the Fanning friction factor. The subscript denotes with or without using the DRA. The DRA performance curve shows how the % DR changes with increasing concentration. It is often an asymptote curve that diminishes at a maximum achievable percentage. DRA products may come with a product sheet specifying the concentration and maximum drag reduction percentage, among other parameters.

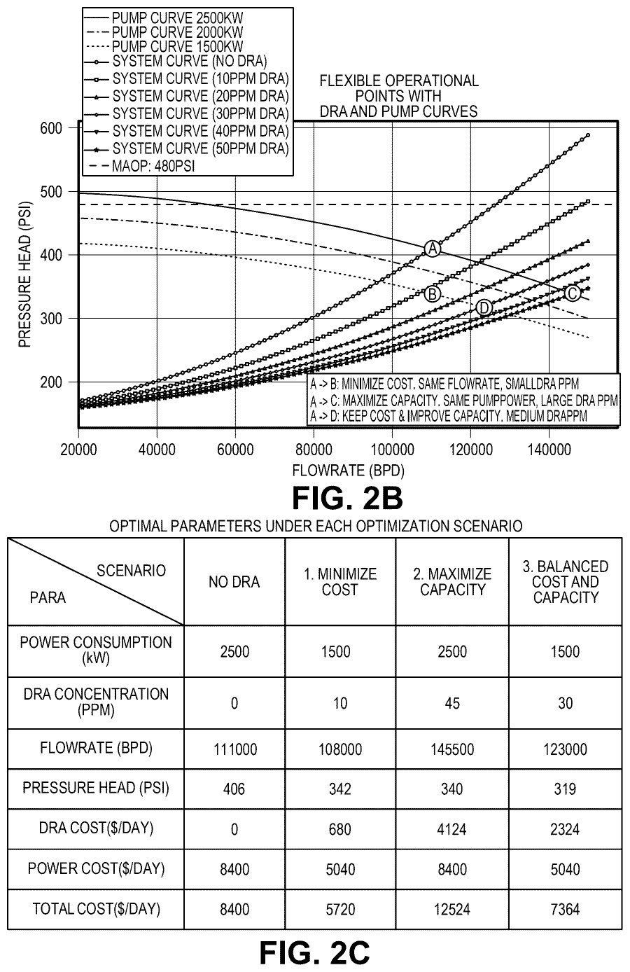

FIG. 3 illustrates a DR % curve range of a DRA, according to an embodiment. Depending on the crude composition, the manufacturer may provide a more accurate performance curve. It may be further refined through trial or actual operation data gathering, and custom machine learning (ML) model may be built when the data range permits.

Depending on the operational targets (e.g., increase flowrate, save cost, reduce pressure, boost bottleneck, etc.), the pipeline may use a combination of pump power and DRA dosage. By carefully balancing the DRA injection dosage and pump power consumption, several benefits may be achieved. The benefits may include flow increase. More particularly, the DRA lowers the frictional pressure loss by reducing turbulence in the flow. This allows operators to increase throughput, sometimes up to doubling the flowrate. The benefits may also include energy management. More particularly, reducing the frictional pressure in a pipeline also saves pumping energy. In many applications entire pump stations may be bypassed. By allowing shutdown of intermediate pump stations, energy and maintenance costs may be reduced. The benefits may also include constraint removal. More particularly, when there is a bottleneck segment that restricts throughput of the entire line, injecting the DRA may effectively alleviate the constraint and allow the flowrate across the entire pipeline to increase. The benefits may also include pressure reduction. Sometimes operators desire to reduce the operational pressure in a pipeline (e.g. lowered MAOP due to pipeline degradation). Injecting the DRA is a fast and effective way to reduce the pipeline pressure without compromising throughput.

In the field, operators often inject a fixed dosage of DRA and fixed pump power, or manually adjust them through inefficient trial and error. This may cause the system to run in a sub-optimal state of capacity and cost. This is due to the lack of an automated optimization workflow, which may combine different sources of information together and identify the optimal operation point.

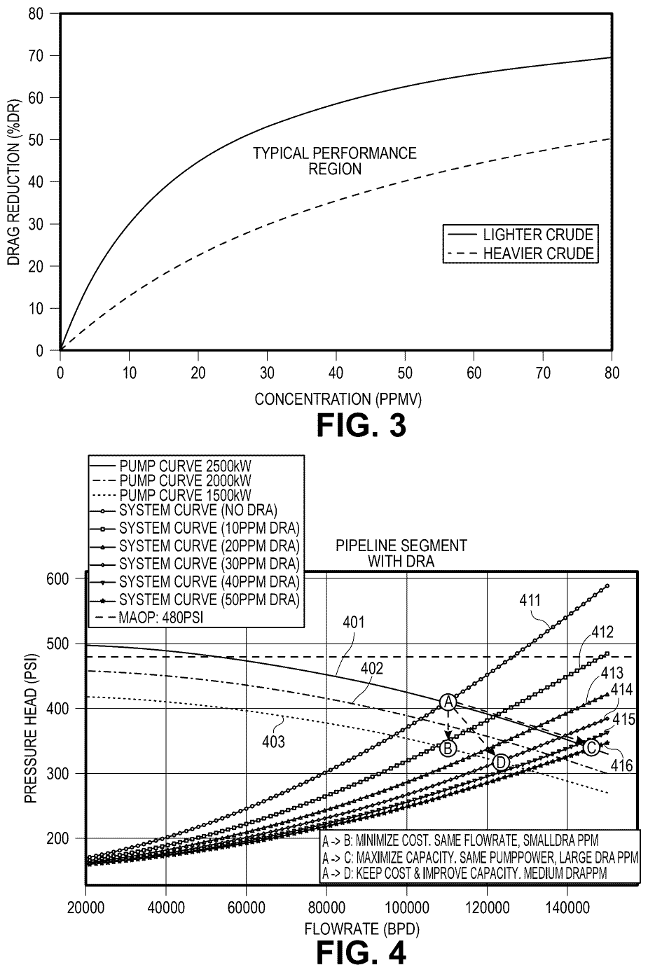

FIG. 4 illustrates a graph showing how to select an optimal operation point, according to an embodiment. More particularly, FIG. 4 shows three pump curves 401-403 under different power settings, and six system curves 411-416 for various DRA injection rates. The intersection points A, B, C, D are operation points with varying pressure head, flowrate, and economic cost.

Table 1 illustrates sample parameters for selecting the optimal operation point, according to an embodiment. The fluid composition is intentionally left empty. The maximum allowable operating pressure (MAOP) is the highest pressure at which a pipeline or system can safely operate. The MAOP may be determined based on factors including the pipe material strength, design specifications, external and internal loads, and safety factors.

TABLE 1

| Parameter | Unit | Value |
|---|---|---|
| MAOP | psi | 480 |
| Unit Power Cost | $/KWh | 0.14 |
| Unit DRA Cost | $/gal | 20 |
| Segment Length | mile | 100 |
| Pipe Diameter | inch | 24 |
| Wall Thickness | inch | 0.375 |
| Roughness | m | 2.80E−05 |
| Composition | % | array |
| Temperature | degC. | 10 |

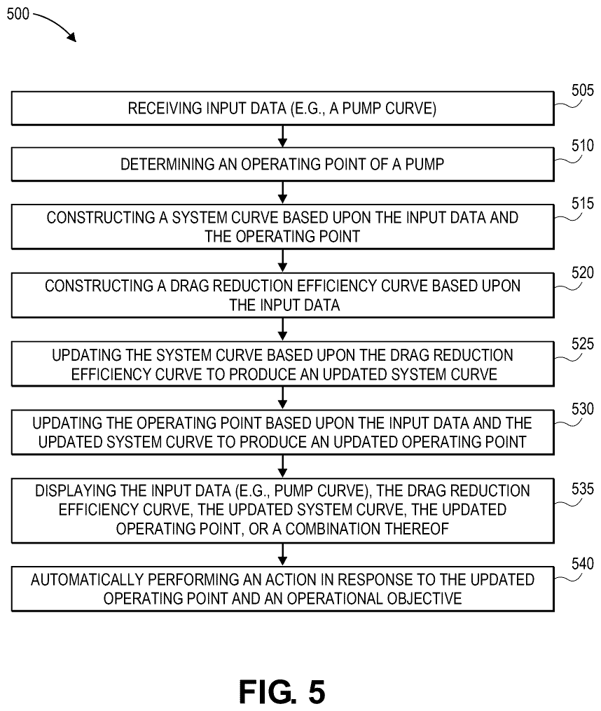

FIG. 5 illustrates a flowchart of a method 500 for modifying (e.g., optimizing) a capacity of a pipeline while reducing emissions, according to an embodiment. More particularly, the method 500 may increase pipeline capacity and reduce emissions by balancing DRAs and pump power management. In addition to oil and/or gas, the method 500 may also or instead be used for pipeline chemicals. An illustrative order of the method 500 is provided below; however, one or more portions of the method 500 may be performed in a different order, simultaneously, repeated, or omitted. At least a portion of the method 500 may be performed with a computing system (described below).

The method 500 may include receiving input data, as at 505. The input data may be or include one or more pump curves. In an example, this may correspond to any of the (e.g., three) pump curves 401-403 illustrated in FIG. 4. Pipeline pump curve information may be received from the pump manufacturer and be provided as part of the technical specifications for the pump. It may also be developed through field measurements and/or simulations. The pump curve represents the relationship between the flowrate and the pressure head, power consumption, and/or efficiency of the pump. The pump curve may be used to find the (e.g., optimal) operating point where the pump runs most efficiently, balancing flow rate, pressure, and/or power consumption. In practice, there may be multiple pumps for a pipeline segment, and different scenarios of individual pump on/off may be accounted for in the combined pump curve.

The input data may also or instead include field measurements related to the pipeline and/or the pump. The field measurements may be or include the flow rate of the fluid, a pressure drop of the fluid, a density of the fluid, a viscosity of the fluid, a temperature of the fluid, or a combination thereof.

The input data may also or instead include controlled tests related to the pipeline and/or the pump. The controlled tests may include (1) injecting a drag-reducing agent (DRA) at different concentrations into the pipeline, and (2) monitoring the flow rate and the pressure drop in response to injecting the DRA at the different concentrations.

The input data may also or instead include empirical modeling related to the pipeline and/or the pump. The empirical modeling may include generating parametric equations and/or numerical models based on the field measurements and/or the controlled tests.

The method 500 may also include determining an operating point of the pump, as at 510. The operating point may be where the pump operates (e.g., most) efficiently. Efficient operation of the pump balances the flow rate, the pressure head, the power consumption, or a combination thereof. In an embodiment, the operating point may be part of the input data.

The method 500 may also include constructing a system curve, as at 515. The system curve may be constructed based upon the input data (e.g., the pump curve(s)) and/or the operating point. The system curve may be constructed without a DRA injection. The system curve may represent a relationship between the flow rate and the pressure head. In an example, this may correspond to the “no DRA” curve 411 in FIG. 4.

The system curve represents the relationship between the flow rate and the total pressure head used by the entire pipeline system. The system curve may be represented by:

$${P}_{system} = {P}_{static} + {P}_{friction} ( Q ) \qquad ( 2 )$$

where P_{static} is the static pressure, which accounts for any elevation differences or pressure requirements, and P_{friction}(Q) is the friction pressure, which roughly increases with the square of the flow rate. The Darcy-Weisbach equation or Hazen-Williams formula may be used to calculate head losses due to friction. The friction factor in the equation depends on the Reynolds number and pipe roughness and can be estimated from the Moody chart.

In another embodiment, for accurate modeling of pipeline hydraulics, simulation software such as PIPESIM® can be used. The simulation input may be or include pipe segment length, pipe diameter, pipe wall thickness, roughness of the inner surface of the pipe, composition of the pipe and/or fluid flowing therethrough, temperature of the pipe and/or fluid flowing therethrough, or a combination thereof. The simulation output may be or include a flowrate vs. pressure relationship.

The method 500 may also include constructing a drag reduction efficiency curve, as at 520. This may also or instead include determining a drag reduction percentage (DR %). The DR % and the drag reduction efficiency curve may be related (e.g., one may be determined or constructed based upon the other). The drag reduction efficiency curve may be constructed based upon the input data (e.g., the pump curve(s)), the operating point, and/or the system curve. In an example, this may correspond to any of the (e.g., five) system curves 412-416 with 10, 20, 30, 40, and 50 ppm DRA injection in FIG. 4. If P and Q vary by more than a predetermined threshold over time, then P may be normalized by Q² when the drag reduction percentage (DR %) is derived, according to the Darcy-Weisbach equation.

The drag reduction efficiency curve may represent an amount of a reduction in drag in the pipeline (% DR). The drag reduction percentage (e.g., % DR) may help to explain how the concentration of the DRA affects the reduction in pressure losses (or drag) in the pipeline. To construct an accurate efficiency curve for each pipeline segment, an initial estimate may be received from the product sheet of the chemical provider. Further tuning may be performed (e.g., using trial data and/or operation data). When sufficient operation data is available (e.g., covering different flowrates and/or injection rates), a data-driven machine learning (ML) model may be custom built for the specific pipeline.

The method 500 may also include updating the system curve based upon the drag reduction efficiency curve to produce an updated system curve, as at 525. When DRA is injected, the % DR applies proportionally to the friction pressure. As a result, the system curve with the DRA can be modified (e.g., corrected) by:

$${P}_{system} = {P}_{static} + {P}_{friction} ( Q ) \times ( 1 - \frac{\% DR}{100} ) \qquad ( 3 )$$

As shown in Equation (3), the values of the system curve may be based upon a sum of the static pressure and a product. The product may include the friction pressure multiplied by a drag reduction variable. The drag reduction variable may include one minus the amount of the drag reduction (% DR) divided by 100.

The method 500 may also include updating the operating point based upon the input data (e.g., the pump curve) and the updated system curve to produce an updated operating point, as at 530. The updated operating point may also be based upon the concentration of the DRA and/or the power consumption of the pump. In an embodiment, the operating point may be updated for each DRA and pump power scenario. An example of this is shown in Table 2.

The updated operating point may be or include an intersection of the pump curve and the updated system curve. The intersection may indicate an expected flow rate in the pipeline and/or an expected pressure drop in the pipeline. For each combination of pump power and DRA concentration, the corresponding flowrate, pressure head, and/or total cost may be determined. For each pair of DRA injection concentration and pump power, there may be an updated system curve (e.g., with the corresponding DRA ppm) and a pump curve as identified from 505 and 525. The intersection of the two curves may be the operating point that indicates the expected flowrate and/or pressure drop. The pressure drop may be smaller than the MAOP parameter; otherwise, the setting may be inoperable.

In addition, the economics for each scenario can be estimated by:

$$Total Cost ( \$ / day ) = Power ( kW ) \times 24 \times Unit Power Cost ( \$ / kWh ) + Flowrate ( bpd ) \times DRA ( ppm ) \times 1 {0}^{- 6} \times 31 \text{.5} \times Unit DRA Cost ( \$ / gal ) \qquad ( 4 )$$

TABLE 2

| Power | DRA | | Pressure | DRA | Power | Total |
|---|---|---|---|---|---|---|
| Consumption | Concentration | Flowrate | Head | Cost | Cost | Cost |
| (kW) | (ppm) | (BPD) | (psi) | ($/day) | ($/day) | ($/day) |
| 1500 | 0 | 97500 | 356.625 | 0 | 5040 | 5040 |
| 2000 | 0 | 105000 | 381.6 | 0 | 6720 | 6720 |
| 2500 | 0 | 111000 | 406.908 | 0 | 8400 | 8400 |
| 1500 | 5 | 103500 | 348.585 | 326.025 | 5040 | 5366.025 |
| 2000 | 5 | 109500 | 374.736 | 344.925 | 6720 | 7064.925 |
| 2500 | 5 | 117000 | 396.572 | 368.55 | 8400 | 8768.55 |
| 1500 | 10 | 108000 | 342.24 | 680.4 | 5040 | 5720.4 |
| 2000 | 10 | 115500 | 365.136 | 727.65 | 6720 | 7447.65 |
| 2500 | 10 | 123000 | 385.692 | 774.9 | 8400 | 9174.9 |
| 1500 | 15 | 112500 | 335.625 | 1063.125 | 5040 | 6103.125 |
| 2000 | 15 | 120000 | 357.6 | 1134 | 6720 | 7854 |
| 2500 | 15 | 127500 | 377.175 | 1204.875 | 8400 | 9604.875 |
| 1500 | 20 | 117000 | 328.74 | 1474.2 | 5040 | 6514.2 |
| 2000 | 20 | 124500 | 349.776 | 1568.7 | 6720 | 8288.7 |
| 2500 | 20 | 132000 | 368.352 | 1663.2 | 8400 | 10063.2 |
| 1500 | 25 | 120000 | 324 | 1890 | 5040 | 6930 |
| 2000 | 25 | 129000 | 341.664 | 2031.75 | 6720 | 8751.75 |
| 2500 | 25 | 135000 | 362.3 | 2126.25 | 8400 | 10526.25 |
| 1500 | 30 | 123000 | 319.14 | 2324.7 | 5040 | 7364.7 |
| 2000 | 30 | 132000 | 336.096 | 2494.8 | 6720 | 9214.8 |
| 2500 | 30 | 138000 | 356.112 | 2608.2 | 8400 | 11008.2 |
| 1500 | 35 | 126000 | 314.16 | 2778.3 | 5040 | 7818.3 |
| 2000 | 35 | 133500 | 333.264 | 2943.675 | 6720 | 9663.675 |
| 2500 | 35 | 141000 | 349.788 | 3109.05 | 8400 | 11509.05 |
| 1500 | 40 | 127500 | 311.625 | 3213 | 5040 | 8253 |
| 2000 | 40 | 136500 | 327.504 | 3439.8 | 6720 | 10159.8 |
| 2500 | 40 | 142500 | 346.575 | 3591 | 8400 | 11991 |
| 1500 | 45 | 129000 | 309.06 | 3657.15 | 5040 | 8697.15 |
| 2000 | 45 | 138000 | 324.576 | 3912.3 | 6720 | 10632.3 |
| 2500 | 45 | 145500 | 340.047 | 4124.925 | 8400 | 12524.925 |

The method 500 may also include displaying the pump curve, the drag reduction efficiency curve, the updated system curve, the updated operating point, or a combination thereof, as at 535.

The method 500 may also include automatically performing an action in response to the updated operating point and an operational objective, as at 540. The action may be or include generating and/or transmitting a signal (e.g., using a computing system) that recommends, instructs, or causes a physical action to occur. The action may also or instead include performing the physical action. The physical action may be or include adjusting (1) an amount and/or the concentration of the DRA to inject into the pipeline and/or (2) the power consumption of the pump.

In an example, assume the original setting is at point A of FIG. 4, with 2500 kW pump power and no DRA injection. Point A is the 1^{st} bold row of Table 2.

Scenario 1: Minimize Cost while Keeping the Same Flowrate

In this scenario, the user wants to maintain the same capacity while minimizing cost. This may be possible because the DRA reduces the frictional pressure thus saves pumping energy. The outcome is going from point A to point B (point B is the 2^{nd} bold row of Table 2). With a small DRA injection rate, the pump power may be reduced, and total cost may drop by $2680/day, while flowrate is almost the same. In practice, sometimes one or more entire pump stations may be bypassed due to the reduced pressure gradient. By allowing shutdown of intermediate pump stations, energy and maintenance costs may be reduced.

### Scenario 2: Maximize Capacity by Injecting Large Concentration of DRA

Because DRA can often achieve % DR of up to 60%, capacity can be improved. For example, the capacity may be doubled. In another example, the outcome is going from point A to point C (point C is the 4th bold row of Table 2). With a 45 ppm injection rate, the flowrate boosts from 111k BPD to 145.5k BPD. As concentration continues increasing, there may be a diminishing effect, and it may become uneconomic.

Another practical use case is debottlenecking. When a segment of the pipeline has restrictions such as MAOP or flowrate, injecting more DRA into this segment may effectively alleviate the bottleneck, which allows the flowrate of the entire pipeline to be increased.

### Scenario 3: Balance Between Saving Cost & Improving Capacity

Due to the flexibility of DRA injections, it may also be possible to reduce cost and improve capacity together, which is an optimal balance point. The outcome is going from point A to point D (point D is the 3^{rd} bold row of Table 2). In this example, there is a 30 ppm DRA injection, and the pump power is decreased from 2500 kW to 1500 kW. As a result, the flowrate is boosted by ~10%, and the cost is also lowered by ~12%. In practice, the electricity or fuel gas prices may vary over time, and sometimes fluctuate due to weather, supply chain disruptions, market volatility, and/or human factors. Thus, it may be beneficial to dynamically balance between saving cost and improving capacity.

### Scenario 4: Reduce an Overall Power Consumption of One or More Pumps in the Pipeline

In response to this operational objective, one or more intermediate pump stations (e.g., in a middle portion of the pipeline) may be bypassed.

### Scenario 5: React in Response to Degradation of the Pipeline or Downgrading of the Pipeline

In response to an operating pressure in the pipeline reaching or exceeding a maximum allowable operation pressure (MAOP) (e.g., due to the degradation or downgrading), the amount and/or concentration of the DRA to be injected may be increased.

### Closed-Loop Control System

As discussed above, the method 500 may optimize pump power and DRA injection rates for cost-effective pipeline operations. This may create a closed-loop control system that continuously monitors variables (e.g., flow rate, pressure, and cost factors such as power prices and DRA effectiveness) and automatically adjusts the pump power and/or DRA injection rates in real-time to maintain optimal operation. The ability to perform real-time adjustments and adapt to fluctuating conditions brings further benefits including, but not limited to, cost savings, increased efficiency, and automation with less human intervention. The real-time optimization may connect the injection system, the SCADA system, the closed-loop control system, and the optimization workflow together.

### Sustainability and Emission Control

The oil and gas industry is among the largest sources of global CO2 emissions, and pipeline operations (including both pumping and compression) contribute to scope 2 emissions. In the U.S. alone, pipeline transportation of natural gas, oil, and refined products account for tens of millions of tons of CO2e (CO2 equivalent) annually. Optimal utilization of DRA and pump power using the method 400 may reduce the scope 2 emissions. Because of reduced drag, operators may use a minimal amount of pump power. If a nominal factor of 400 gCO2e/kWh is applied, the pump power savings (or bypassing the pump) can contribute to emission control with an estimation that 6 gallons of DRA may save up to 1 ton of CO2e emissions.

### Autonomous Optimization for Drag Reducer

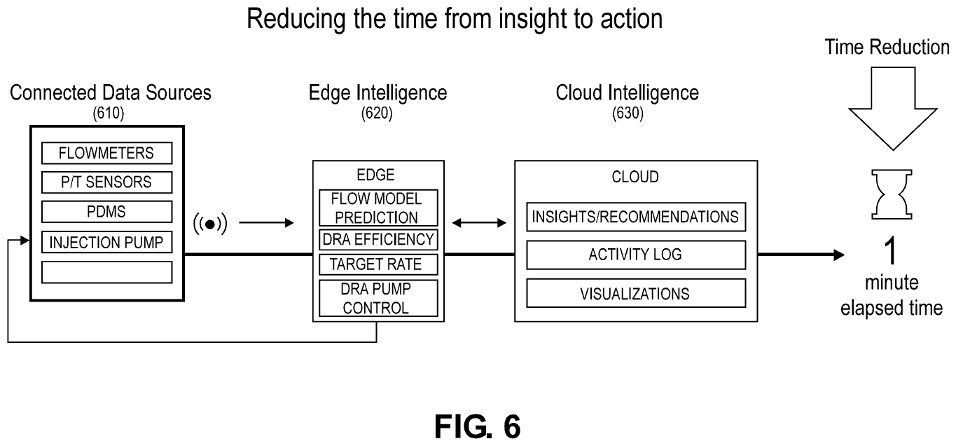

FIG. 6 illustrates a schematic view of a system 600 for autonomously optimizing a drag reducer, according to an embodiment. The system 600 may be configured to perform at least a portion of the method 500 in FIG. 5. The system 600 may include one or more connected data sources 610 such as flowmeters, pressure sensors, temperature sensors, a petroleum management data system (PDMS), an injection pump, or a combination thereof. The system 600 may also include edge intelligence 620 that is in communication with the data sources 610. The edge intelligence may be configured to determine or generate a flow model prediction, DRA efficiency, a target flow rate, a DRA pump control, or a combination thereof based upon the data from the data sources 610. The system 600 may also include cloud intelligence 630 that is in communication with the edge intelligence 620. The cloud intelligence may be configured to generate insights, recommendations, an activity log, visualizations, or a combination thereof based upon the edge intelligence 620. The system 600 may operate more efficiently than conventional systems (e.g., within less than 1 minute).

### Exemplary Computing System

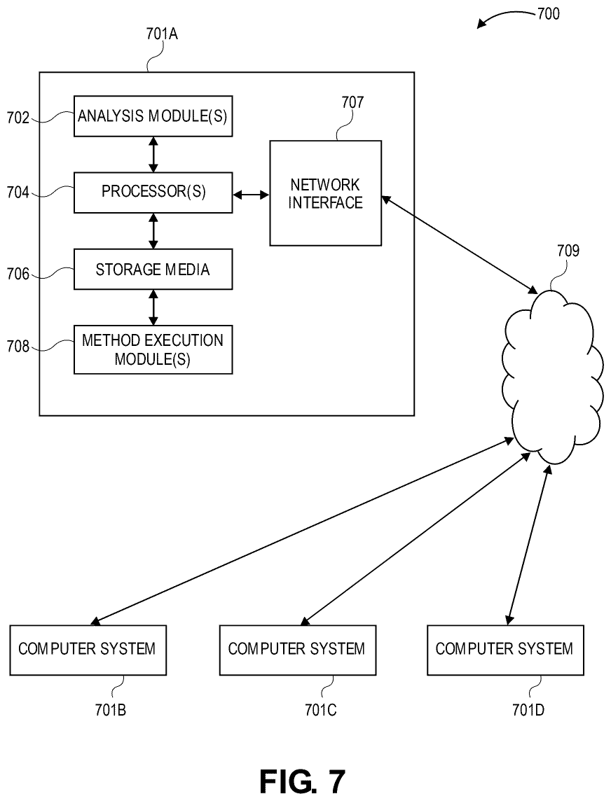

In some embodiments, the methods of the present disclosure may be executed by a computing system. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis modules 702 that are configured to perform various tasks according to some embodiments, such as one or more methods disclosed herein. To perform these various tasks, the analysis module 702 executes independently, or in coordination with, one or more processors 704, which is (or are) connected to one or more storage media 706. The processor(s) 704 is (or are) also connected to a network interface 707 to allow the computer system 701A to communicate over a data network 709 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor may include a microprocessor, microcontroller, processor module or subsystem, programmable integrated circuit, programmable gate array, or another control or computing device.

The storage media 706 may be implemented as one or more computer-readable or machine-readable storage media. Note that while in the example embodiment of FIG. 7 storage media 706 is depicted as within computer system 701A, in some embodiments, storage media 706 may be distributed within and/or across multiple internal and/or external enclosures of computing system 701A and/or additional computing systems. Storage media 706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 700 contains one or more de-risking module(s) 708. In the example of computing system 700, computer system 701A includes the de-risking module 708. In some embodiments, a single de-risking module may be used to perform some aspects of one or more embodiments of the methods disclosed herein. In other embodiments, a plurality of de-risking modules may be used to perform some aspects of methods herein.

It should be appreciated that computing system 700 is merely one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 700, FIG. 7), and/or through manual control by a user who may make determinations regarding whether a given step, action, template, model, or set of curves has become sufficiently accurate for the evaluation of the subsurface three-dimensional geologic formation under consideration.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for modifying a capacity of a pipeline while reducing emissions, the method comprising:
receiving input data related to a pump that is configured to cause a fluid to move through a pipeline;
determining an operating point of the pump;
generating a system curve based upon the input data and the operating point;
generating a drag reduction efficiency curve based upon the input data;
updating the system curve based upon the drag reduction efficiency curve to produce an updated system curve; and
updating the operating point based upon the input data and the updated system curve to produce an updated operating point.

2. The method of claim 1, wherein the input data comprises a pump curve that represents a power consumption of the pump, an efficiency of the pump, and a relationship between a flow rate of the fluid through the pump and a pressure head of the pump.

3. The method of claim 2, wherein the input data also comprises field measurements related to the pipeline and/or the pump, wherein the field measurements comprise the flow rate of the fluid, a pressure drop of the fluid, a density of the fluid, a viscosity of the fluid, a temperature of the fluid, or a combination thereof.

4. The method of claim 3, wherein the input data also comprises controlled tests related to the pipeline and/or the pump, wherein the controlled tests comprise (1) injecting a drag-reducing agent (DRA) at different concentrations into the pipeline, and (2) monitoring the flow rate and the pressure drop in response to injecting the DRA at the different concentrations.

5. The method of claim 4, wherein the input data also comprises empirical modeling related to the pipeline and/or the pump, wherein the empirical modeling comprises generating parametric equations and/or numerical models based on the field measurements and/or the controlled tests.

6. The method of claim 4, wherein the system curve represents a relationship between the flow rate and a pressure head of the pump, wherein values of system curve are based upon a sum of a static pressure of the fluid and a friction pressure of the fluid, and wherein the static pressure accounts for elevation differences in the pipeline.

7. The method of claim 1, wherein the drag reduction efficiency curve describes how a concentration of a drag-reducing agent (DRA) being introduced into the fluid in the pipeline reduces pressure losses and/or the drag in the pipeline.

8. The method of claim 1, wherein the values of the system curve are based upon a sum of a static pressure of the fluid and a product, wherein the product comprises a friction pressure of the fluid multiplied by a drag reduction variable, and wherein the drag reduction variable comprises one minus an amount of the drag reduction divided by 100.

9. The method of claim 1, wherein the input data comprises a pump curve corresponding to the pump, wherein the updated operating point comprises an intersection of the pump curve and the updated system curve, and wherein the intersection indicates an expected flow rate in the pipeline and an expected pressure drop in the pipeline.

10. The method of claim 1, further comprising displaying the updated system curve and the updated operating point.

11. A computing system, comprising:
one or more processors; and
a memory system comprising one or more non-transitory computer-readable media storing instructions that, when executed by at least one of the one or more processors, cause the computing system to perform operations, the operations comprising:
receiving input data, wherein the input data comprises a pump curve corresponding to a pump that causes a fluid to move through a pipeline;
determining an operating point of the pump where the pump operates at or above a predetermined efficiency;
generating a system curve based upon the input data and the operating point, wherein the system curve is generated without introducing a drag-reducing agent (DRA) into the pipeline;
generating a drag reduction efficiency curve based upon the input data, wherein the drag reduction efficiency curve represents an amount of a reduction in drag in the pipeline in response to the DRA being introduced into the fluid in the pipeline;
updating the system curve based upon the drag reduction efficiency curve to produce an updated system curve; and
updating the operating point based upon the input data and the updated system curve to produce an updated operating point, wherein the updated operating point is also based upon a concentration of the DRA and/or a power consumption of the pump.

12. The computing system of claim 11, wherein efficient operation of the pump balances a flow rate of the fluid, a pressure head of the pump, and the power consumption of the pump.

13. The computing system of claim 11, wherein the operations further comprise generating and/or transmitting a signal that recommends, instructs, or causes a physical action to occur related to the pump and/or the pipeline.

14. The computing system of claim 13, wherein the physical action comprises adjusting an amount and/or the concentration of the DRA to introduce into the pipeline.

15. The computing system of claim 13, wherein the physical action comprises adjusting the power consumption of the pump.

16. A non-transitory computer-readable medium storing instructions that, when executed by one or more processors of a computing system, cause the computing system to perform operations, the operations comprising:
receiving input data, wherein the input data comprises a pump curve corresponding to a pump that causes a fluid to move through a pipeline;
determining an operating point of the pump where the pump operates at or above a predetermined efficiency;
generating a system curve based upon the input data and the operating point, wherein the system curve is generated without introducing a drag-reducing agent (DRA) into the pipeline;
generating a drag reduction efficiency curve based upon the input data, wherein the drag reduction efficiency curve represents an amount of a reduction in drag in the pipeline in response to the DRA being introduced into the fluid in the pipeline;
updating the system curve based upon the drag reduction efficiency curve to produce an updated system curve;
updating the operating point based upon the input data and the updated system curve to produce an updated operating point, wherein the updated operating point is also based upon a concentration of the DRA and a power consumption of the pump; and
automatically performing an action in response to the updated operating point and an operational objective.

17. The non-transitory computer-readable medium of claim 16, wherein the action comprises increasing an amount and/or the concentration of the DRA to introduce to a first level in response to the operational objective being to minimize cost while maintaining substantially a same flow rate of the fluid.

18. The non-transitory computer-readable medium of claim 17, wherein the action comprises increasing the amount and/or the concentration of the DRA to introduce to a second level in response to the operational objective being changed to maximize the flow rate, and wherein the second level is greater than the first level.

19. The non-transitory computer-readable medium of claim 18, wherein a physical action comprises increasing the amount and/or the concentration of the DRA to introduce to a third level and reducing the power consumption of the pump in response to the operational objective being changed to balance the cost with the flow rate, and wherein the third level is between the first and second levels.

20. The non-transitory computer-readable medium of claim 16, wherein the action comprises:
bypassing an intermediate pump station in a middle portion of the pipeline in response to the operational objective being to reduce an overall power consumption of a plurality of pumps in the pipeline; and/or
increasing an amount and/or the concentration of the DRA to introduce in response to an operating pressure of the fluid in the pipeline reaching or exceeding a maximum allowable operating pressure (MAOP) due to degradation of the pipeline or downgrading of the pipeline.
